(19) United States
(12) Patent Application Publication
(10) Pub. No.: US 2020/0042573 A1
(43) Pub. Date: Feb. 6, 2020

(54) COMPONENT-LEVEL PERFORMANCE ANALYSIS FOR COMPUTING SYSTEMS

(71) Applicant: salesforce.com, inc., San Francisco, CA (US)

(72) Inventor: Martin Presler-Marshall, Chapel Hill, NC (US)

(21) Appl. No.: 16/050,152

(22) Filed: Jul. 31, 2018

(51) Int. Cl. G06F 17/18

(52) U.S. Cl. CPC G06F 17/18

(57) ABSTRACT

Systems, devices, and techniques are disclosed for outlier discovery system selection. A statistical test may be applied to measurements for a top-level performance metric for a computing system that includes an application and a computing device. Based on results of the statistical test, it may be determined that there has a been a statistically significant change in the performance of the computing system. Either the statistical test or another statistical test may be applied to measurements for a component-level performance metric of the computing system. The component-level performance metric may include a metric for a component of the computing system. Based on results of the statistical test or the another statistical, it may be determined that there has a been a statistically significant change in the performance of the component of the computing system. An indication of the component of the computing system may be generated.

### BACKGROUND

Performance monitoring systems may use statistical tests to analyze the overall performance of computing systems to determine when changes in performance are statistically significant. This may allow a performance monitoring system to distinguish between performance changes caused by random variations in performance and those that may have an underlying cause beyond random variation. The use of statistical tests by a performance monitoring system to analyze overall performance may not be able to identify such a cause of a change in performance of a computing system. Performance changes that are the result of unknown changes to some aspect of a computing system may by detectable by statistical tests used by a performance monitoring system, but without an indication as to what caused the performance change.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system for component-level performance analysis for computing systems according to an implementation of the disclosed subject matter.

FIG. 2 shows an example arrangement for component-level performance analysis for computing systems according to an implementation of the disclosed subject matter.

FIG. 3 shows an example arrangement for component-level performance analysis for computing systems according to an implementation of the disclosed subject matter.

FIG. 4 shows an example arrangement for component-level performance analysis for computing systems according to an implementation of the disclosed subject matter.

FIG. 5A shows an example arrangement for component-level performance analysis for computing systems according to an implementation of the disclosed subject matter.

FIG. 5B shows an example arrangement suitable for component-level performance analysis for computing systems according to an implementation of the disclosed subject matter.

FIG. 6 shows exampled visualizations suitable for component-level performance analysis for computing systems according to an implementation of the disclosed subject matter.

FIG. 7 shows an example procedure suitable for component-level performance analysis for computing systems according to an implementation of the disclosed subject matter.

FIG. 8 shows a computer according to an implementation of the disclosed subject matter.

FIG. 9 shows a network configuration according to an implementation of the disclosed subject matter.

### DETAILED DESCRIPTION

Techniques disclosed herein enable component-level performance analysis for computing systems, which may allow analysis of the performance of a computing system at the component level to determine which components may be responsible for changes in the overall performance of the computing system. The top-level performance of a computing system may be measured while the computing system is in operation, generating top-level performance data. Component-level performance of the computing system may also be measured, generating component-level performance data. The top-level performance data may be analyzed using statistical tests to determine if the performance data shows a change in the top-level performance of the computing system. When a statistically significant change in the top-level performance of the computing system is identified, the component-level performance data may be analyzed using statistical tests similar to those used to analyze the top-level performance data. The analysis of the component-level performance data may be used to identify components of the computing system which showed statistically significant changes in performance that are concurrent with the change in the top-level performance of the computing system. This may allow for the identification of components of the computing system that may have caused the change in the top-level performance of the computing system identified by the analysis of the top-level performance data.

Top-level performance data may be generated by taking measurements of a computing system according to a top-level performance metric for the computing system. The top-level performance metric for a computing system may be any suitable metric by which the top-level performance of a computing system may be judged, and may be selected based on the properties of the computing system, including the way the computing system operates and the intended use of the computing system. For example, the top-level performance metric may be related to the performance of a specified task by the computing system. A top-level performance metric may be measured as, for example, an amount of time, an amount of processor time, a number of CPU cycles, a number of accesses to volatile or non-volatile storage, an amount of network bandwidth, or any other property that may be associated with the operation of a computing system. For example, the top-level performance metric for the performance of a website during continuous integration testing may be an end-to-end measurement of the amount of time between when a user logs-in to the website and a specific section of the website has loaded completely on the user's computing device after the user has logged-in. The top-level performance metric for the website may be measured using, for example, automated tools which may access the website, enter log-in data, and access the specific section of the web site after logging-in. The top-level performance metric for a service, such as a website or application service, hosted in cloud computing environment may be an end-to-end measurement of the amount of time between when a user logs-in to the service and the service is delivered to the user's computing device after the user has logged-in. The top-level performance metric for the service in the cloud computing environment may be measured while the service is in live operation based on the performance of the service when being accessed by actual users of the service.

Component-level performance data may be generated by taking measurements of components of a computing system according to component-level performance metrics. A component of a computing system may be, for example, software, hardware, or some combination thereof, which may perform some action that may contribute to the performance being measured according to a top-level performance metric. For example, a component-level performance metric may be related to the performance of a specified task by a component of the computing system such as, for example, rendering of an element on a user interface, execution of a database query, retrieval of data from volatile or non-volatile storage, and sending of a message over a network connection. A component-level performance metric may be measured as, for example, an amount of time, an amount of processor time, a number of CPU cycles, a number of accesses to volatile or non-volatile storage, an amount of network bandwidth, or any other property that may be associated with the operation of a computing system. For example, a component-level performance metric may measure the latency of a network link used by the computing system, the latency of queries submitted to a database, the latency of retrieving data from storage, the amount of time it takes a server to process a request from a web browser, the amount of time it takes a web browser to render a web page element, or the amount of processor time or number of CPU cycles needed to complete a specific task. Multiple component-level performance metrics may be measured for the same component of the computing system.

Top-level performance metrics and component-level performance metrics may be measured during continuous integration testing of a computing system. A computing system may have its top-level and component-level performance metrics measured before any changes are made to the computing system, establishing a baseline level of performance for the computing system and the components of the computing system. A change may then be made deliberately to the computing system. For example, a hardware component may be changed, a software application may have a procedure or function rewritten, a web page may have an HTML or scripted element rewritten, a setting of the computing system may be changed, a network connection used by the computing system may be changed, or any other suitable change may be made to the computing system. After the change is made to the computing system, the computing system may again have its top-level and component level-performance metrics measured.

A statistical test may be applied to the measurements taken according to the top-level performance metric for the computing system from both before and after the change to the computing system. The statistical test may be, for example, an analysis of variance test or a 2-tailed t-test. The results of the statistical test may identify whether there was a statistically significant change in the top-level performance of the computing system after the change to the computing system was made. For example, a test user may be used to log-in to a service. The log-ins may be performed using automated tools. End-to-end measurements of an amount of time between when the test user goes to a log-in page for the service and the service is delivered to the test user's computing device after the test user has logged-in may vary across multiple log-ins by the test user both before and after the change is made to the computing system. A statistical test may be applied to the measured amount of times to compare times measured before the change to the computing system to the times measured after the change to the computing system. The result of the statistical test may identify whether the times measured after the change to the computing system show a statistically significant increase or decrease from the times measured before the change to the computing system.

When the results of the statistical test identify a statistically significant change in the top-level performance of the computing system after the change to the computing system was made, statistical tests may be applied to the measurements taken according to the component-level performance metrics of the computing system on a per-component-level performance metric basis. The statistical test applied to measurements for each component-level performance metric may be, for example, an analysis of variance test or a 2-tailed t-test, and may be the same statistical test that was applied to measurements for the top-level performance metric. The same statistical test may be used for each component-level performance metric for which measurements were made. The results of the statistical test as applied to an individual component-level performance metric for which measurements were made may identify whether there was a statistically significant change in the component-level performance measured by the metric after the change to the computing system was made. For example, a decrease in top-level performance of a service based on a statistically significant increase in the measured amount of time between when the test user goes to a log-in page for the service and the service is delivered to the test user's computing device after the user has logged-in may be identified after a change is made to the computing system. Statistical tests may then be applied to the measurements for component-level performance metrics that were made before and after the change to the computing system. For example, statistical tests may be applied to measurements, from before and after the change to the computing system, of the latency of a database query performed during the delivery of the service to the test user to identify whether there was a statistically significant increase or decrease in the measured latency after the change to the computing system was made.

Applying statistical tests to the measurements for the component-level performance metrics may allow each component-level performance metric to be examined for indications of a performance change that may account for the identified statistically significant change in the top-level performance of the computing system. Components associated with component-level performance metrics whose measurements showed a statistically significant performance change may be identified. This may allow for a determination of how the change made to the computing system resulted in the identified statistically significant change in the top-level performance of the computing system. For example, the top-level performance of a service may have shown degradation after the change to a computing system. The application of statistical tests to the measurements for component-level performance metrics may identify a statistically significant increase in latency in a particular component-level performance metric. This increase in latency may account for the degradation in the top-level performance of the computing system. The particular component-level performance metric for which the statistically significant increase in latency was identified may be associated with a particular component of the computing system. In some cases, the particular component associated with the particular component-level performance metric may be the component of the computing system that was changed, indicating that the change caused the performance of that component to degrade. In some cases, the particular component associated with the particular component-level performance metric may not be the component that was changed, indicating that the change made to the computing system may have had unintended deleterious effects on components of the computing system that were not changed. The application of statistical tests to the measurements for component-level performance metrics may identify statistically significant changes in performance in multiple component-level performance metrics, associated with multiple different components. The changes in performance may be uniform in direction, for example, all showing either improvement or degradation, or may not be uniform in direction, for example, with some component-level performance metrics showing improvement and other component-level performance metrics showing degradation. For example, a change made to a single component of a computing system may degrade the performance of that component as measured according to its associated component-level performance metric, and may also result in degradation or improvement in the performance of other components of the computing system even if those components were not changed.

During continuous integration testing of a computing system, top-level and component-level performance metrics may be measured before and after every change to the computing system. The results of the applied statistical tests may then be used to make additional changes to the computing system or modify or undo changes that have already been made. For example, when a change to a component is identified as causing degradation in the performance of other components of the computing system, changes may be made to the other components to mitigate the performance degradation, or the change itself may be modified or undone.

Top-level performance metrics and component-level performance metrics may be measured during application performance monitoring of a computing system. A computing system may have its top-level and component-level performance metrics measured continuously during live operation of the computing system. For example, a service or website may be hosted in a cloud computing environment. The service or website may be live, for example, available to users, or otherwise deployed for non-test usage.

A statistical test may be applied to the measurements taken according to the top-level performance metric for the computing system as measured over any two distinct time periods during the operation of the computing system. For example, the statistical test may be applied at set intervals to measurements taken according to the top-level performance metric from a set time period, such as every two minutes, comparing measurements taken between four minutes and two minutes prior with measurements taken between two minutes prior and the time at which the statistical test is applied. The statistical test may be, for example, an analysis of variance test or a 2-tailed t-test. The results of the statistical test may identify whether there has been a statistically significant change in the top-level performance of the computing system during its operation. For example, a service hosted in a cloud computing environment may be accessed by users of the service. End-to-end measurements of an amount of time between when users go to a log-in page for the service and the service is delivered to the users' computing devices after the users have logged-in may vary across multiple log-ins by multiple users over the time during which the computing system is in operation. A statistical test may be applied to the measured amount of times to compare times measured over two different time periods, which may be contiguous or may have a gap between them. The result of the statistical test may identify whether the times measured in one of the time periods show a statistically significant increase or decrease from the times measured in the other of the time periods.

When the results of the statistical test identify a statistically significant change in the top-level performance of the computing system between any two time periods, statistical tests may be applied to the measurements for the component-level performance metrics of the computing system on a per-component-level performance metric basis. The statistical test applied to measurements for each component-level performance metric may be, for example, an analysis of variance test or a 2-tailed t-test, and may be the same statistical test that was applied to measurements for the top-level performance metric. The same statistical test may be used for each component-level performance metric for which measurements were made. The results of the statistical test as applied to an individual component-level performance metric for which measurements were made may identify whether there was a statistically significant change in the component-level performance measured by the metric between the two time periods. For example, a decrease in the top-level performance of a service based on a statistically significant increase in the measured amount of time between when users go to a log-in page for the service and the service is delivered to the users' computing devices after the users have logged-in may be identified as having occurred during a second time period when compared to a prior occurring first time period. Statistical tests may then be applied to the measurements taken according to the component-level performance metrics during the first and second time periods. For example, statistical tests may be applied to measurements, from the first and second time periods, of the latency of a database query performed during the delivery of the service to users to identify whether there was a statistically significant increase or decrease in the measured latency between the first and second time periods.

Applying statistical tests to the measurements for the component-level performance metrics may allow each component-level performance metric to be examined for indications of a performance change that may account for the identified statistically significant change in the top-level performance of the computing system. Components associated with component-level performance metrics whose measurements showed a statistically significant performance change may be identified. This may allow for a determination of components whose performance change between two time periods resulted in the identified change in the top-level performance of the computing system. For example, the top-level performance of a service may have shown statistically significant degradation between two time periods. The application of statistical tests to the measurements for component-level performance metrics may identify a statistically significant increase in latency in a particular component-level performance metric. The increase in latency may account for the degradation in the top-level performance of the computing system. The particular component-level performance metric for which the statistically significant increase in latency was measured may be associated with a particular component of the computing system. The identification of the component that showed the statistically significant increase in latency may allow for further investigation into causes of the increased latency, allowing for more efficient and precise troubleshooting of issues with a live computing system. For example, components of the service that may have been changed by an operator of the cloud computing environment that hosts the service without the knowledge of the operator of the service may be identified. The application of statistical tests to the measurements for component-level performance metrics may identify statistically significant changes in performance in multiple component-level performance metrics for multiple components. The changes in performance may be uniform in direction, for example, all showing either improvement or degradation, or may not be uniform in direction, for example, with come component-level performance metrics showing improvement and other component-level performance metrics showing degradation. For example, between two time periods various changes may have been made to several components of a computing system, some of which may result in an overall degradation of the performance of the components as measured according to their associated component-level performance metric, and some of which may result in an overall improvement in the performance of the components. The various changes may also result in degradation or improvement in the performance of other components of the computing system even if those components were not changed between the two time periods. In some cases, the improvement or degradation of the performance of a component, as identified during application performance monitoring, may result from external factors and not from any change to a component of the computing system being monitored. For example, increased latency in a component may be the result of increased latency in a network link that is outside the control of both the operator of a service that is hosted in a cloud computing environment and the operator of the cloud computing environment

In some implementations, statistical tests may be applied to the measurements for the component-level performance metrics of the computing system on a per-component-level performance metric basis even if the results of the statistical test applied to the measurements for the top-level performance metric do not identify a statistically significant change in the top-level performance of the computing system between any two time periods. This may allow for the identification of statistically significant changes in the component-level performance of multiple components that offset each other, resulting in no statistically significant change to top-level performance.

During application performance monitoring of a computing system, top-level and component-level performance metrics may be measured continuously. The results of the applied statistical tests may be used to identify issues with components of the computing system that may be negatively impacting the top-level performance of the computing system. This may allow an operator of a computing system that is hosted in a cloud computing environment to determine when issues with the computing system are being caused by changes made by the operator of the cloud computing environment or changes external to the cloud computing environment. For example, a service hosted in a cloud computing environment may have its top-level performance degraded due to the addition of new users to the service or problems with network connections between users and the cloud computing environment. The use of statistical tests may allow for the identification of issues with components of the computing system without the use of threshold alarms or triggers.

Measurements may be taken according to top-level performance metrics and component-level performance in any suitable manner. For example, computing systems may have built-in hardware and software components for measurement and event logging that may take measurements according to top-level performance metrics and component-level performance metrics. Measurements may also be taken according to top-level performance metrics by, for example, a performance monitoring system that may be part of software or hardware added to the computing system, or may be part of another computing device that may communicate with the computing system whose top-level performance is being measured according to top-level performance metrics. Measurements may also be taken according to component-level performance metrics may by, for example, the performance monitoring system that may be part of software or hardware added to the computing system, or may be part of another computing device that may communicate with the computing system whose component-level performance is being measured according to component-level performance metrics. Other software or hardware, for example, separate from the performance monitoring system, may also be used to take measurements according to top-level and component-level performance metrics.

A graphical user interface may present the results of the application of the statistical tests to the measurements in the component-level performance data. The graphical user interface may visually depict the components for which component-level performance data was obtained, and may visually represent the results of the application of the statistical tests to the component-level performance data. The visual representation of the results of the application of the statistical tests to the component-level performance data may allow a user to more easily identify which components of the computing system had statistically significant performance changes identified by the statistical tests and may be responsible for changes in the top-level performance of the computing system. Any suitable visual representations may be used. For example, components for which a decrease in performance was identified may be colored in a first color, such as red, components for which an improvement in performance was identified may be colored in a second color, such as green, and components for which no statistically significant change in performance was identified may be colored in a third color, such as grey.

In some implementations, the results of the application the statistical tests to the component-level performance data may be used to make automated changes to the computing system. During application performance monitoring, a performance monitoring system, or other system, may be able to make changes to components of the computing system to ameliorate or mitigate a degradation in top-level performance. For example, a performance monitoring system may be able to change settings the computing system uses for a network connection when latency in the network connection is identified as a cause of a decrease in the top-level performance of the computing system by the statistical tests applied to the component-level performance data for the components of the computing system.

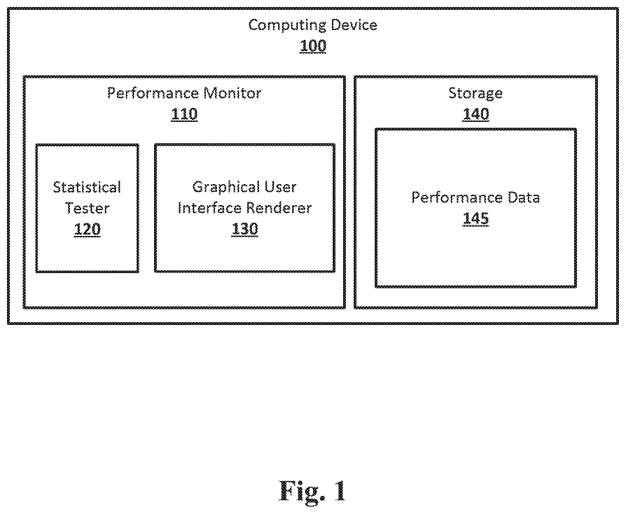

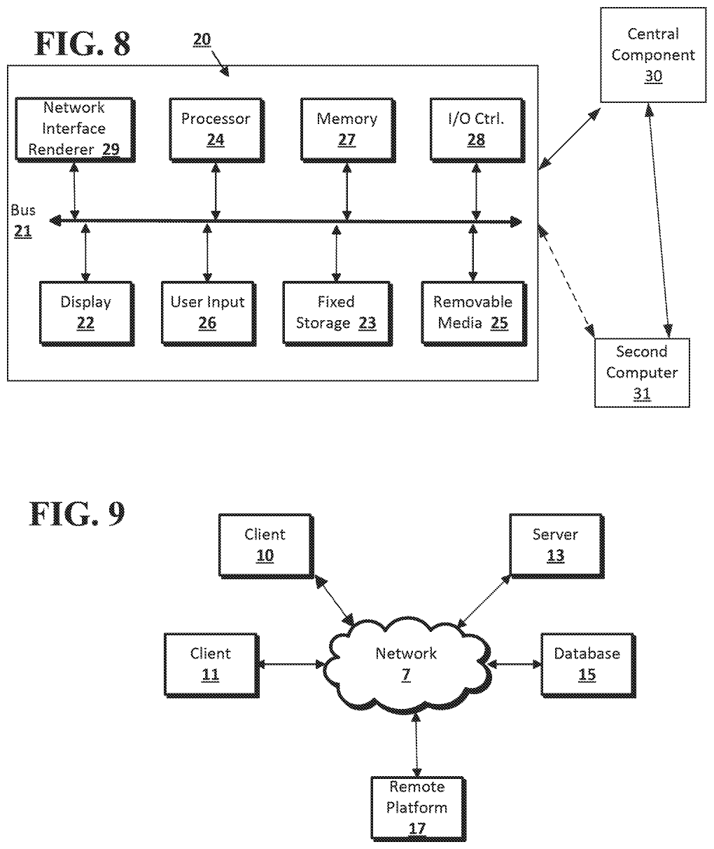

FIG. 1 shows an example system for component-level performance analysis for computing systems according to an implementation of the disclosed subject matter. A computing device 100 may be any suitable computing device, such as, for example, a computer 20 as described in FIG. 8 or component thereof, for component-level performance analysis for computing systems. The computing device 100 may include a performance monitor 110 and a storage 140. The computing device 100 may be a single computing device, or may include multiple connected computing devices, and may be, for example, a laptop, a desktop, an individual server, a server cluster, a server farm, or a distributed server system, or may be a virtual computing device or system, or any suitable combination of physical and virtual systems. For simplicity, generic components such as the processor, short and long-term storage, the operating system, much of the database management system are not shown. The computing device 100 may be part of a computing system and network infrastructure, or may be otherwise connected to the computing system and network infrastructure, including a larger server network which may include other server systems similar to the computing device 100. The computing device 100 may include any suitable combination of central processing units (CPUs), graphical processing units (GPUs), and tensor processing units (TPUs), which may be used to implement the various components of the performance monitor 110.

The performance monitor 110 may be a component of the computing device 100 that may include any suitable combination of hardware and software for taking measurements according to top-level and component-level performance metrics of a computing system to generate top-level and component-level performance data, receiving top-level and component-level performance data generated with measurements taken by another computing device, applying statistical tests to top-level and component-level performance data, rendering the results of the statistical tests as part of a graphical user interface, and implementing automated changes to a computing system based on the results of the statistical tests. The performance monitor 110 may, for example, include any suitable hardware and software for monitoring both top-level and component-level performance of a computing system, including, for example, an application or service, running on the computing device 100 or another computing device. The performance monitor 110 may monitor top-level and component-level performance by measuring the top-level performance of a computing system according to a top-level performance metric for that computing system, and measuring component-level performance of the components of the computing system according to component-level performance metrics for the components of the computing system. Measurements taken by the performance monitor 110 may be used to generate top-level performance data and component-level performance data. The performance monitor 110 may also receive top-level and component-level performance data generated by a different computing device. For example, a computing device separate from the computing device 100 may host an application or service, and may monitor the performance of that application or service and its components to generate the top-level and component-level performance data. Top-level and component-level performance data generated or received by the performance monitor 110 may be stored as performance data 145 in the storage 140 of the computing device 110. The storage 140 may be any suitable combination of hardware and software for storing data on, or in a manner accessible to, the computing device 110.

The performance monitor 110 may include a statistical tester 120 for applying statistical tests to top-level and component-level performance data. The statistical tester 120 may be any suitable hardware and software for applying statistical tests, such as analysis of variance tests and 2-tailed t-tests, to top-level and component-level performance data that includes measurements taken according to top-level and component level performance metrics. The statistical tester 120 may use the statistical tests to determine if top-level performance data for a computing system shows a statistically significant change in the top-level performance of the computing system. The statistical tester 120 may, for example, apply a statistical test to top-level performance data for a computing system generated based on measurements made according to a top-level performance metric for the computing system before and after a deliberate, known, change is made to the computing system. This statistical tester 120 may determine if any difference between the top-level performance data from before the change and from after the change is statistically significant. The statistical tester 120 may also, for example, apply a statistical test to top-level performance data for a computing system generated based on measurements made according to top-level performance metrics for the computing system taken during any two time periods while the computing system is in operation. The statistical tester 120 may determine if any difference between the top-level performance data from the two time periods is statistically significant. The two time periods may be continuous or discontinuous.

When the statistical tester 120 determines that a difference in the top-level performance of a computing system is statistically significant based on the top-level performance data from the computing system, the statistical tester 120 may use the statistical tests to determine if component-level performance data for the computing system shows a statistically significant change in the component-level performance of any of the components of the computing system. The statistical tester 120 may, for example, apply a statistical test to component-level performance data for components of the computing system generated based on measurements made according to component-level performance metrics for the computing system before and after a deliberate, known, change is made to the computing system. The statistical tester 120 may determine if any difference between the component-level performance data for a particular component from before the change and from after the change is statistically significant. The statistical tester 120 may also, for example, apply a statistical test to component-level performance data for a computing system generated based on measurements made according to component-level performance metrics for the components of the computing system taken during any two time periods while the computing system is in operation. The statistical tester 120 may determine if any difference between the component-level performance data from the two time periods for a particular component is statistically significant. The component-level performance data used by the statistical tester 120 may be from the same time periods as the top-level performance data in which the statistical tester 120 identified a statistically significant change in top-level performance.

The performance monitor 110 may include a graphical user interface renderer 130, which may be any suitable combination of hardware and software for rendering the results of the statistical tests as part of a graphical user interface. For example, the statistical tester 120 may have determined that there was a statistically significant decrease in the performance of a first component of the computing system between two time periods based on component-level performance data. The graphical user interface renderer 130 may render a visual representation of the computing system which may visually depict the components for which component-level performance data was obtained. The graphical user interface renderer 130 may visually represent the results of the application of the statistical tests to the component-level performance data. The visual representation of the results of the application of the statistical tests to the component-level performance data may, for example, depict the first component, for which a statistically significant decrease in performance between the two time periods was identified, in a first color, such as red, depict the components for which a statistically significant improvement in performance between the two time periods was identified in a second color, such as green, and depict the components for which no statistically significant change in performance was identified between the two time periods in a third color, such as grey.

The performance monitor 110 may also implement automated changes to a computing system based on the results of the statistical tests. For example, the performance monitor 110 may be able alter the operation of a computing system and its components automatically in order to mitigate a statistically significant decrease in the top-level performance of the computing system. The performance monitor 110 may directly change settings used by a computing system or components thereof, for example, to adjust the operation of a component that had a statistically significant decrease in performance according to the statistical tester 120, or to adjust the operation of another component that did not have a statistically significant decrease in performance order to offset or mitigate the effect on top-level performance by the component that did have a statistically significant decrease in performance according to the statistical tester 120. The identification of components that have experienced a statistically significantly decrease in performance by the statistical tester 120 may allow issues with the top-level performance of a computing system in live operation to be automatically detected, diagnosed, and mitigated by the performance monitor 110.

The performance monitor 110 may also generate an indication of any the components of the computing system for which a statistically significant change in component-level performance was identified. For example, a notification may be sent to another computing device, for example, via email, text message, instant message, in-app notification, or any other suitable type of notification that may be communicated between computing devices. The notification may identify any the components of the computing system for which a statistically significant change in component-level performance was identified.

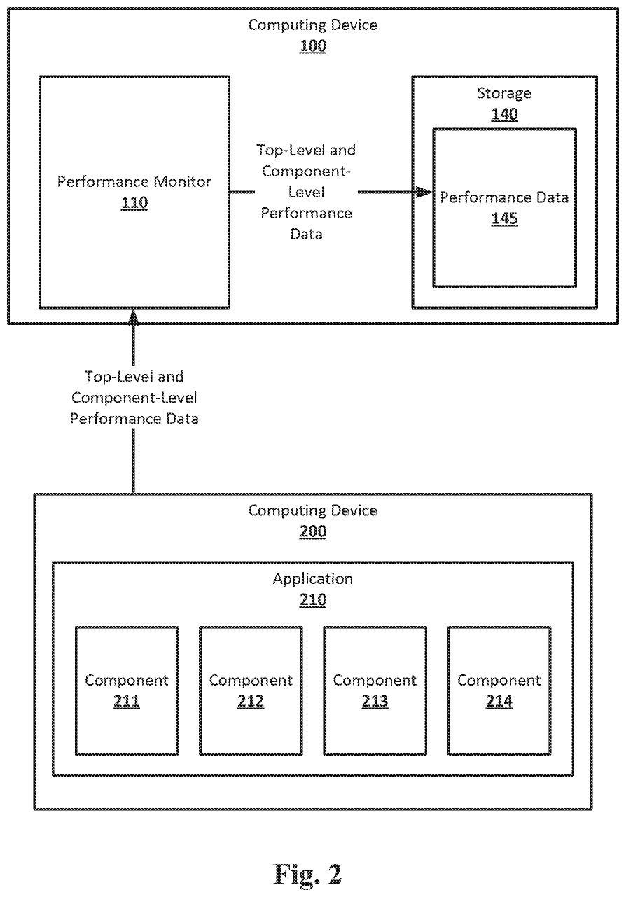

FIG. 2 shows an example arrangement for component-level performance analysis for computing systems according to an implementation of the disclosed subject matter. The data performance monitor 110 may receive top-level and component-level performance data. The top-level and component-level performance data may be received from a computing device 200, which may be running an application 210, implementing a computing system.

The computing device 200 may be any suitable computing device, including, for example, a server system that is part of a cloud computing environment. The application 210 may be any suitable application that may be run on the computing device 200, and may, for example, implement a service that may be accessed by users of the computing device 200 directly, or from other computing devices that may be connected to the computing device 200 in any suitable manner. The application 210 may be, for example, a service that may be accessible through an application for smartphones and other computing devices, or may be a service provided to one or many organizations and accessible through computing devices used by those organizations. The application 210 may include components 211, 212, 213, and 214. The components 211, 212, 213, and 214 may be any suitable combination of hardware and software that may allow the application 210 to run on the computing device 210. For example, the component 211 may be a networking component and may include the hardware and software used by the application 210 to establish a network link with computing devices outside the computing device 200. The component 212 may be, for example, a database query component which may handle the retrieval of data from a database on the computing device 200 in response to a query received from another computing device.

In some implementations, components of a computing system may reside on multiple computing devices. For example, components of the computing system formed by the computing device 200 and the application 210 may reside on user computing devices that access the application 210 on the computing device 200. For example, a component of a computing system may be part of a web browser or application that runs on a user device and is designed to access the service provided by the application 210, accept input from the user of the computing device being used to access the service provided by the application 210, and display data received from the application 210 to the user.

The top-level and component-level performance data may be gathered in any suitable manner. For example, the performance monitor 110 may directly monitor the computing device 200 and application 210, measuring both top-level performance and component-level performance according to top-level performance metrics for the computing system and component-level performance metrics for the components 211, 212, 213, and 214. The performance monitor 110 may also receive top-level and component-level performance data that has been gathered by, for example, monitoring tools on the computing device 200, or from another computing device that is responsible for monitoring the performance of the computing device 200 and the application 210.

The top-level and component-level performance data may be gathered over any suitable time period. For example, during continuous integration testing of the application 210, the top-level and component-level performance data may be gathered before a change is made to any of the components 211, 212, 213, and 214 to establish baselines for the top-level performance of the computing system and the component-level performance of the components 211, 212, 213, and 214. The change may then be made, and top-level and component-level performance data may be gathered to determine the top-level performance of the computing system and the component-level performance of the components 211, 212, 213, and 214 after the change. During live operation of the computing system, the top-level performance data and component-level performance data may be gathered continuously, or may be gathered at specified intervals or based on the occurrence of specified events.

The top-level and component-level performance data received by the performance monitor 110 may be stored in the storage 140 as the performance data 145. The performance data 145 may include any top-level and component-level performance data stored so that it may be retrieved later by the performance monitor 110 in order to have statistical tests applied by the statistical tester 120.

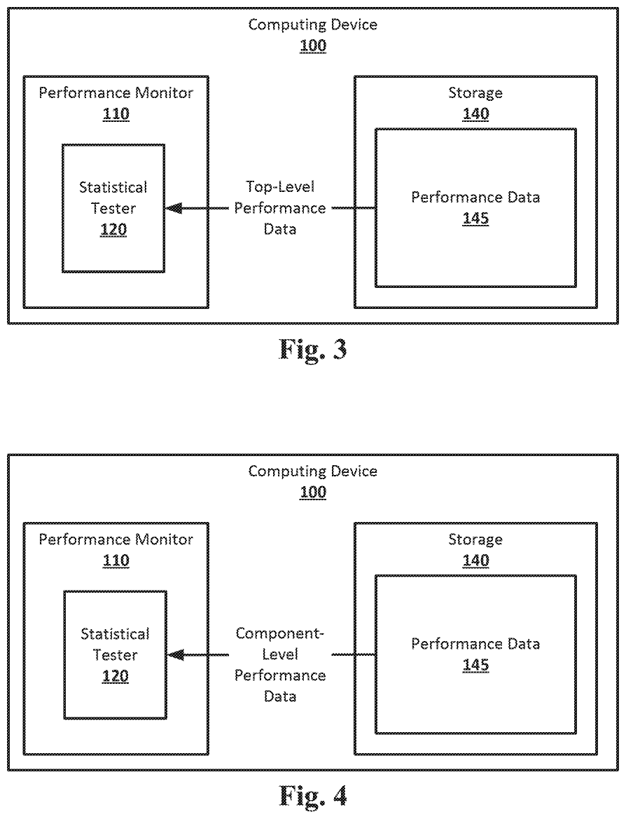

FIG. 3 shows an example arrangement for component-level performance analysis for computing systems according to an implementation of the disclosed subject matter. The statistical tester 120 of the performance monitor 110 may apply a statistical test to the top-level performance data that was received by the performance monitor 110 and stored in the storage 140 as part of the performance data 145. The statistical tester 120 may apply a statistical test, such as an analysis of variance test or 2-tailed t-test, to the top-level performance for the computing system that includes computing device 200 and the application 210. The statistical tester 120 may use the statistical tests to determine if the top-level performance data shows a statistically significant change in the top-level performance of the computing system including the computing device 200 and the application 210.

The statistical tester 120 may apply the statistical test to the top-level performance data at any suitable time. For example, the statistical tester 120 may apply a statistical test to top-level performance data after a specified amount of time has elapsed after a change is made to the computing system, for example, during continuous integration testing. The statistical tester 120 may apply a statistical test to the top-level performance data at specified intervals, or on the occurrence of specified events, for example, during application performance monitoring when the computing system is in live operation.

The statistical tester 120 may divide the top-level performance data into two time periods in any suitable manner. For example, the top-level performance data may be divided into a first time period which may include top-level performance data gathered during the establishment of a baseline level of performance for the computing system before a change was made to computing system, and a second time period which may include top-level performance data gathered for a specified amount of time after the change was made to the computing system. The top-level performance data may be divided into first and second time periods by dividing the top-level performance data in half chronologically, or by selecting top-level performance data gathered over two discontinuous time periods.

The results of the statistical test applied by the statistical tester 120 to the top-level performance data for the computing system including the computing device 200 and the application 210 may indicate whether top-level performance of the computing system experienced a statistically significant change between the time periods into which the top-level performance data was divided. The statistical tester 120 may determine that there was a statistically significant decrease in top-level performance, a statistically significant increase in top-level performance, or no statistically significant change in top-level performance. For example, the top-level performance metric for the computing system may be a measurement of the time taken for the application 210 to complete the rendering of an account website on a user computing device after the user logs-in. If, after a change is made to the component 211, the top-level performance data for the computing system shows increases in the amount of time to complete the rendering of the website as compared to before the change was made, and, for example, the increase is consistent enough, and/or of great enough magnitude, the statistical tester 120 may determine that there has been a statistically significant decrease in the top-level performance of the computing system. In some cases, for example, if such an increase is smaller, or not consistent, the statistical tester 120 may determine that the increase is the result of noise or random variation in the top-level performance data and does not have statistical significance.

FIG. 4 shows an example arrangement for component-level performance analysis for computing systems according to an implementation of the disclosed subject matter. The statistical tester 120 of the performance monitor 110 may apply a statistical test to the component-level performance data that was received by the performance monitor 110 and stored in the storage 140 as part of the performance data 145. The statistical tester 120 may apply a statistical test, such as an analysis of variance test or 2-tailed t-test, to the component-level performance for the components 211, 212, 213, and 214 of the computing system that includes computing device 200 and the application 210. The statistical tester 120 may use the statistical tests to determine if the component-level performance data for any of the components 211, 212, 213, and 214 shows a statistically significant change in the component-level performance of the component 211, 212, 213, or 214.

The statistical tester 120 may apply the statistical test to the component-level performance data after a statistical test applied to the top-level performance data identified a statistically significant change in the top-level performance of the computing system including the computing device 200 and the application 210. For example, the statistical tester 120 may apply a statistical test to the component-level performance data after a statistical test applied to the top-level performance data indicated a statistically significant decrease in the top-level performance of the computing system. In some implementations, the statistical tester 120 may apply the statistical test to the component-level performance data after a statistical test applied to the top-level performance data did not identify a statistically significant change in the top-level performance of the computing system.

The statistical tester 120 may divide the component-level performance data into two time periods in the same manner that the top-level performance data to which the statistical test was applied was divided into two time periods. For example, if the top-level performance data was divided into a first time period including top-level performance data gathered during the establishment of a baseline level of performance for the computing system before a change was made to computing system, and a second time period including top-level performance data gathered for a specified amount of time after the change was made to the computing system, the component-level performance data may be divided into a first time period including component-level performance data gathered during the establishment of the baseline level of performance for the computing system before the change was made to computing system, and a second time period including component-level performance data gathered for the specified amount of time after the change was made to the computing system. The component-level performance data in the first time period may have been gathered at the same time as the top-level performance data in the first time period, and the component-level performance data in the second time period may have been gathered at the same time as the top-level performance data in the second time period. If the top-level performance data was divided into first and second time periods by dividing the top-level performance data in half chronologically, or by selecting top-level performance data gathered over two discontinuous time periods, the component-level performance data may similarly be divided in half, or may be divided into first and second time periods using component-level performance data from the same two discontinuous time periods from which the top-level performance data was selected.

The results of the statistical test applied by the statistical tester 120 to the component-level performance data for the computing system including the computing device 200 and the application 210 may indicate whether the component-level performance of any of the components 211, 212, 213, and 214 of the computing system experienced a statistically significant change between the time periods into which the component-level performance data was divided, concurrent with the statistically significant change in top-level performance identified by the statistical tester 120. The statistical tester 120 may determine, for each of the components 211, 212, 213, and 214, that there was a statistically significant decrease in the component-level performance of the component, a statistically significant increase in the component-level performance of the component, or no statistically significant change in the component-level performance of the component. For example, the component-level performance metric for the component 212 may be a measurement of the time taken for the component 212 complete the retrieval of data from a database on the computing device 200 in response to a query received from another computing device. If, after a change is made to the component 212, the component-level performance data for the component 212 shows increases in the amount of time to complete the retrieval of data from the database on the computing device 200 in response to a query received from another computing device as compared to before the change was made, and the increase is, for example, consistent enough, and/or of great enough magnitude, the statistical tester 120 may determine that there has been a statistically significant decrease in the component-level performance of the component 212. If such an increase in the time take to complete the retrieval is, for example, smaller, or not consistent, the statistical tester 120 may determine that the increase is the result of noise in the component-level performance data and does not have statistical significance.

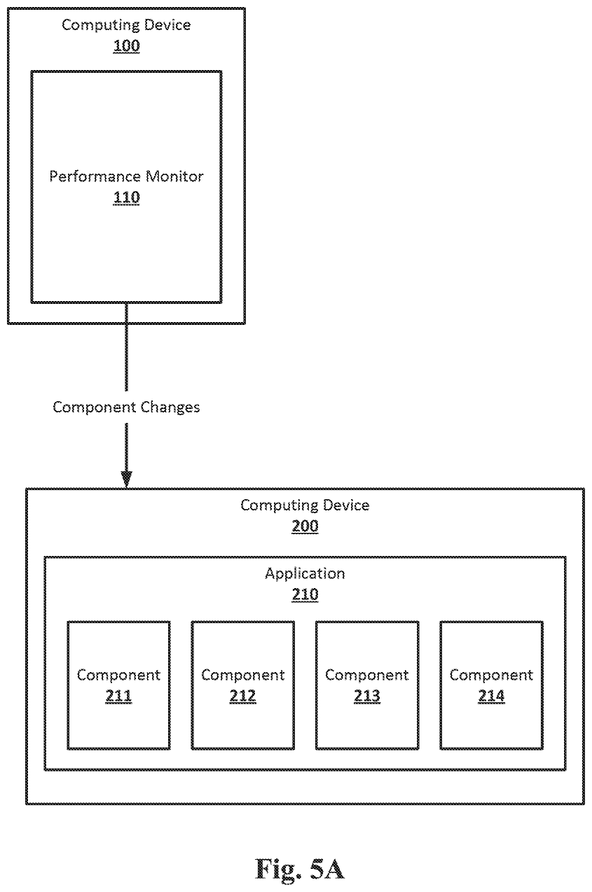

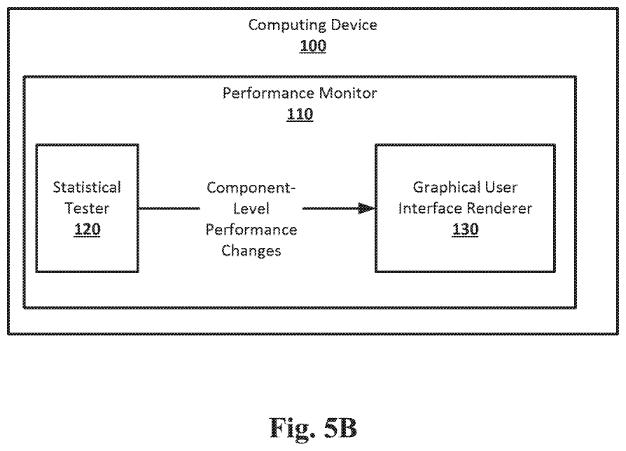

FIG. 5A shows an example arrangement for component-level performance analysis for computing systems according to an implementation of the disclosed subject matter. The performance monitor 110 may implement automated changes to the computing system including the computing device 200 and the application 210 based on the results of the statistical tests applied by the statistical tester 120 to the top-level and component-level performance data gathered from the computing system and stored with the performance data 145. For example, the performance monitor 110 may be able alter the operation of the computing system and the components 211, 212, 213, and 214 automatically in order to mitigate a statistically significant decrease in the top-level performance of the computing system identified by the statistical tester 120. For example, the statistical tester 120 may identify a statistically significant decrease in the top-level performance of the computing system and in the component-level performance of the component 212. The performance monitor 110 may directly change settings used by the component 212, for example, changing settings used by the component 212 to access a database on the computing device 200. This change may offset or mitigate the decrease in the component-level performance of the component 212, which may also offset or mitigate the decrease in the top-level performance of the computing system. The performance monitor 110 may also adjust the operation of another component that did not have a statistically significant decrease in performance, such as any of the components 211, 213, or 214, in order to offset or mitigate the effect on top-level performance by the component 212. The performance monitor 110 may also be able to make adjustments that are not directly to the components 211, 212, 213, and 214 of the application 210. For example, the performance monitor 110 may make adjustments to the computing device 200.

FIG. 5B shows an example arrangement for component-level performance analysis for computing systems according to an implementation of the disclosed subject matter. The graphical user interface renderer 130 may receive the identification of component-level performance changes from the statistical tester 120 and use them to render a graphical user interface to be presented on a display, which may be any suitable combination of hardware and software for rendering the results of the statistical tests as part of a graphical user interface. For example, the statistical tester 120 may have determined that there is a statistically significant difference in the performance of several components of a computing system over two time periods based on component-level performance data. The graphical user interface renderer 130 may render a visual representation of the computing system which may visually depict the components for which component-level performance data was obtained. The graphical user interface renderer 130 may visually represent the results of the application of the statistical tests to the component-level performance data. The visual representation of the results of the application of the statistical tests to the component-level performance data may, for example, depict the components for which a statistically significant decrease in performance between the two time periods was identified in a first color, such as red, depict the components for which a statistically significant improvement in performance between the two time periods was identified in a second color, such as green, and depict the components for which no statistically significant change in performance was identified between the two time periods in a third color, such as grey. The graphical user interface, rendered by the graphical user interface renderer 130, may be displayed, for example, to a user of the computing device 100. The rendered graphical user interface may allow a user to visually inspect and diagnose issues with the computing system including the computing device 200 and the application 210 based on the depiction of the components 211, 212, 213, and 214. The graphical user interface renderer 130 may update the rendered graphical user interface whenever new component-level performance changes are received from the statistical tester 120. The graphical user interface renderer 130 may also render a visual representation of the top-level performance of the computing system and any statistically significant changes identified from the top-level performance data.

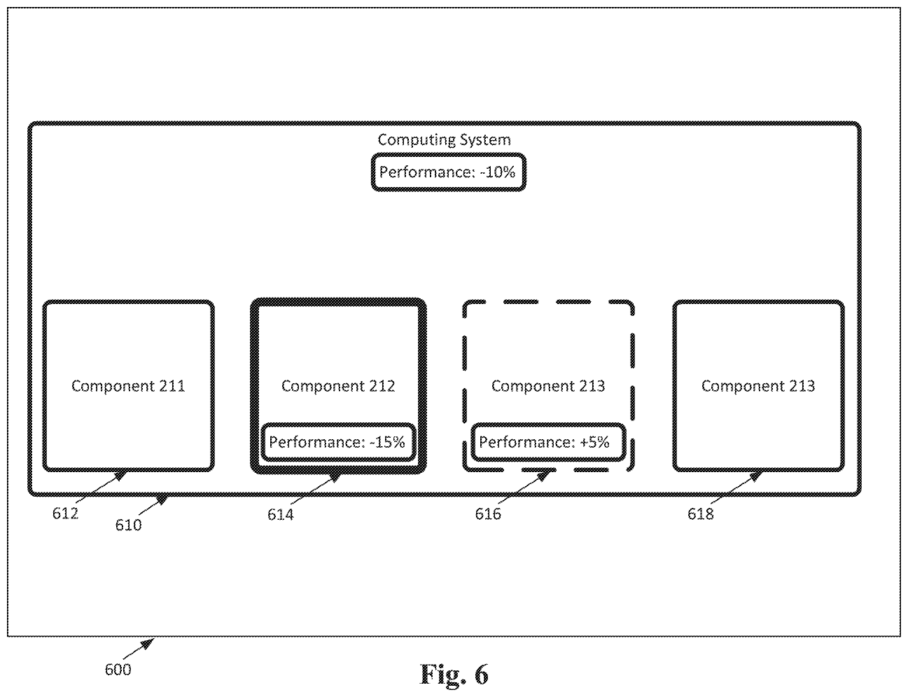

FIG. 6 shows example visualizations for component-level performance analysis for computing systems according to an implementation of the disclosed subject matter. The graphical user interface renderer 130 may render a graphical user interface 600 for display to a user of the computing device 100. The graphical user interface 600 may be rendered to visually depict the results of the statistical tests performed by the statistical tester 120 on the top-level and component-level performance data gathered from the computing system including the computing device 200 and the application 210.

A visualization 610 displayed as part of the graphical user interface 600 may be a visualization for the top-level performance of the computing system including the computing device 200 and the application 210. The visualization 610 may include an indication of any top-level performance change identified by the statistical tester 120. For example, if the statistical tester 120 determined that the top-level performance of the computing system decreased by 10%, this may be displayed as part of the visualization 610. Any other suitable data may be displayed as part of the visualization 610, including, for example, the measurements from the top-level performance data for the top-level performance metrics to which the statistical tester 120 applied statistical tests, and an identification of the time periods covered by the top-level and component-level performance data to which the statistical tester 120 applied statistical tests.

The components 211, 212, 213, and 214 may be represented in the graphical user interface 600 by visualizations 612, 614, 616, and 618. The visualizations 612, 614, 616, and 618 may include indications of any component-level performance changes in the components 211, 212, 213, and 214 identified by the statistical tester 120. For example, if the statistical tester 120 determined that the component-level performance of the component 212 decreased by 15%, this may be displayed as part of the visualization 614. The visualization 614 may also be rendered to visually indicate the component-level performance of the component 212 decreased, for example, through coloration of the visualization 614 or changing the borders of the visualization 614. As another example, if the statistical tester 120 determined that the component-level performance of the component 213 improved by 5%, this may be displayed as part of the visualization 616. The visualization 616 may also be rendered to visually indicate the component-level performance of the component 213 improved, for example, through coloration of the visualization 616 or changing the borders of the visualization 616.

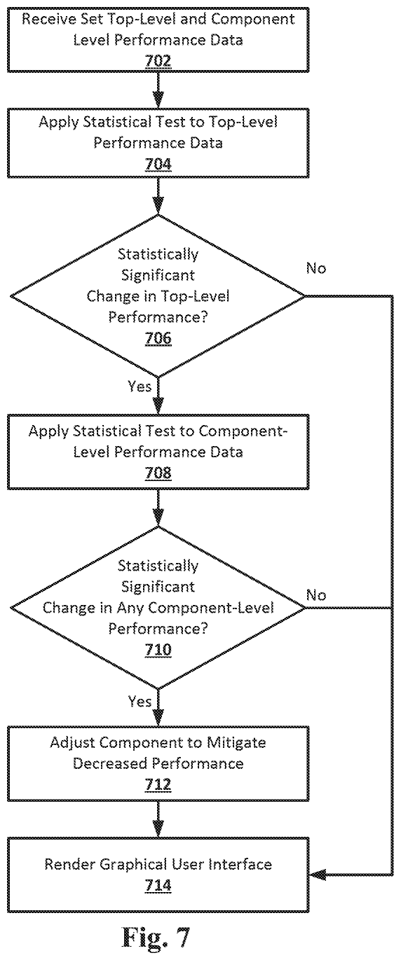

FIG. 7 shows an example procedure suitable for component-level performance analysis for computing systems according to an implementation of the disclosed subject matter. At 702, top-level and component-level performance data may be received. For example, the performance monitor 110 may receive top-level and component-level performance data generated by measuring the top-level and component-level performance of a computing system, such as the computing system including the computing device 200 and the application 210. The top-level performance may be measured according to a top-level performance metric for the computing system. The component-level performance may be measured according to component-level performance metrics for the components, such as the components 211, 212, 213, and 214, of the computing system. The measurements may be performed by the performance monitor 110 of the computing device 100, by the computing device 200, or by any other suitable computing device that may be able to monitor and measure the performance of the computing device 200, the application 210, and the components 211, 212, 213, and 214.

At 704, a statistical test may be applied to top-level performance data. For example, the statistical tester 120 may apply a statistical test, such as analysis of variance of test or 2-tailed t-test, to determine if the top-level performance data shows a statistically significant change in the top-level performance of the computing system between two time periods. The top-level performance data may be divided into the time periods based on, for example, a time when a change was made to the computing system, or on other suitable criteria. The two time periods may be continuous or discontinuous, and may be of the same length, or may be of different lengths. The statistical test may be applied to top-level performance data at any suitable time, for example, at set intervals or based on the occurrence of events. The application of the statistical test may identify whether there has been a statistically significant change in the top-level performance of the computing system based on the top-level performance data.

At 706, if a statistically significant change in the top-level performance is identified by the statistical test, flow may proceed to 708, where the statistical test may be applied to component-level performance data. Otherwise, flow may proceed to 714, where a graphical user interface may be rendered to present the results of the statistical test to a user.

At 708, a statistical test may be applied to component-level performance data. For example, the statistical tester 120 may apply a statistical test, such as an analysis of variance test or 2-tailed t-test, to determine if the component-level performance data shows a statistically significant change in the component-level performance of any of the components, such as the components 211, 212, 213, and 214, of the computing system between the same two time periods used for the top-level performance data. The component-level performance data may be divided into the two time periods in the same manner that the top-level performance data was divided into two time periods. This may result in the statistical test being applied to component-level performance data that was generated through measurements taken at the same time as measurements used to generate the top-level performance data to which the statistical test was applied. The statistical test applied to the component-level performance data may be the same statistical test that was applied to the top-level performance data. The statistical test may be applied to the component-level performance data as soon as possible after a statistically significant change in top-level performance is identified by applying the statistical test to the top-level performance data. The statistical test may be applied separately to each component-level performance metric for which a measurement is available in the component-level performance data. The application of the statistical test may identify whether there has been a statistically significant change in the component-level performance of any of the components 211, 212, 213, and 214 of the computing system based on the component-level performance data for the components 211, 212, 213, and 214.

At 710, if a statistically significant change in the top-level performance is identified by the statistical test, flow may proceed to 712, where an adjustment may be applied to a component to mitigate decreased performance. Otherwise, flow may proceed to 714, where a graphical user interface may be rendered to present the results of the statistical test to a user.

At 712, a component of the computing system may be adjusted to mitigate decreased performance. For example, the performance monitor 110 may implement automated changes to the computing system including the computing device 200 and the application 210 based on the results of the statistical tests applied by the statistical tester 120 to the top-level and component-level performance data gathered from the computing system and stored with the performance data 145. The performance monitor 110 may adjust or alter the operation of any of the components 211, 212, 213, and 214 automatically in order to mitigate a statistically significant decrease in the top-level performance of the computing system identified by the statistical tester 120. The performance monitor 110 may also generate an indication of any the components 211, 212, 213, and 214 of the computing system for which a statistically significant change in component-level performance was identified. For example, a notification may be sent to another computing device, for example, via email, text message, instant message, in-app notification, or any other suitable type of notification that may be communicated between computing devices. The notification may identify any the components 211, 212, 213, and 214 of the computing system for which a statistically significant change in component-level performance was identified.

At 714, a graphical user interface may be rendered. For example, the graphical user interface renderer 130 may render a visual representation of the computing system which may visually depict the components 211, 212, 213, and 214 for which component-level performance data was obtained. The graphical user interface renderer 130 may visually represent the results of the application of the statistical tests to the top-level and component-level performance data. The visual representation of the results of the application of the statistical tests to the top-level and component-level performance data may, for example, depict a component, such as the component 212, for which a statistically significant decrease in performance between the two time periods was identified, in a first color, such as red, depict the components for which a statistically significant improvement in performance between the two time periods was identified in a second color, such as green, and depict the components for which no statistically significant change in performance was identified between the two time periods in a third color, such as grey. This may allow a user to more readily diagnose issues with components that may be affecting the top-level performance of the computing system.

Implementations of the presently disclosed subject matter may be implemented in and used with a variety of component and network architectures. FIG. 8 is an example computer 20 suitable for implementing implementations of the presently disclosed subject matter. As discussed in further detail herein, the computer 20 may be a single computer in a network of multiple computers. As shown in FIG. 8, computer may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 9.

Many other devices or components (not shown) may be connected in a similar manner (e.g., document scanners, digital cameras and so on). Conversely, all of the components shown in FIG. 8 need not be present to practice the present disclosure. The components can be interconnected in different ways from that shown. The operation of a computer such as that shown in FIG. 8 is readily known in the art and is not discussed in detail in this application. Code to implement the present disclosure can be stored in computer-readable storage media such as one or more of the memory 27, fixed storage 23, removable media 25, or on a remote storage location.

FIG. 9 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method comprising:
applying a statistical test to measurements for a top-level performance metric for a computing system comprising at least one application and at least one computing device;
determining based on results of the statistical test applied to the measurements for the top-level performance metric that there has a been a statistically significant change in the performance of the computing system;
applying either the statistical test or another statistical test to one or more measurements for a component-level performance metric of the computing system, wherein the component-level performance metric comprises a metric for a component of the computing system;
determining based on results of the statistical test or the another statistical test applied to the one or more measurements for the component-level performance metric that there has a been a statistically significant change in the performance of the component of the computing system; and
generating an indication of the component of the computing system.

2. The computer-implemented method of claim 1, further comprising applying either the statistical test or the another statistical test to measurements for one or more additional component-level performance metrics, wherein each one of the one or more additional component metrics comprises a metric for one of one or more additional components of the computing system.

3. The computer-implemented method of claim 1, further comprising automatically applying an adjustment to the component of the computing system in response to determining based on the results of the statistical test or the another statistical test applied to the one or more measurements for the component-level performance metric that there has a been a statistically significant change in the performance of the component of the computing system.

4. The computer-implemented method of claim 1, wherein applying a statistical test to measurements for a top-level performance metric for a computing system comprising at least one application and at least one computing device further comprises dividing the measurements into a first time period and a second time period based on times when the measurements were taken.

5. The computer-implemented method of claim 1, further comprising rendering a graphical user interface comprising a visual representation of the determined statistically significant change in the performance of the component of the application in the computing system.

6. The computer-implemented method of claim 1, wherein the measurements for the top-level performance metric comprise amounts of time taken by the computing system to complete a specified task.

7. The computer-implemented method of claim 1, wherein the measurements for the top-level performance metric and the one or more measurements for the component-level performance metric are taken for a time period before a change is made to the component and for a time period after the change is made to the component.

8. The computer-implemented method of claim 1, wherein the measurements for the top-level performance metric and the one or more measurements for the component-level performance metric are taken continuously while the computing system is in operation, and further comprising:
dividing the measurements for the top-level performance metric into two time periods based on the times the measurements were taken before applying the statistical test.

9. The computer-implemented method of claim 1, wherein the one or more measurements for the component-level performance metric comprise measurements of an amount of time taken by a routine of the application to complete a task, wherein the task comprises a rendering of an element on a user interface of the computing device, an execution of a database query, a retrieval of data from volatile or non-volatile storage of the computing device, or a sending of a message over a network connection of the computing device.

10. A computer-implemented system for component-level performance analysis for computing systems comprising:
one or more storage devices; and
a processor that retrieves from the one or more storage devices measurements for a top-level performance metric for a computing system comprising at least one application and at least one computing device, applies a statistical test to the measurements for the top-level performance metric for a computing system comprising at least one application and at least one computing device, determines based on results of the statistical test applied to the measurements for the top-level performance metric that there has a been a statistically significant change in the performance of the computing system, applies either the statistical test or another statistical test to one or more measurements for a component-level performance metric of the computing system, wherein the component-level performance metric comprises a metric for a component of the computing system, determines based on results of the statistical test or the another statistical test applied to the one or more measurements for the component-level performance metric that there has a been a statistically significant change in the performance of the component of the computing system, and generates an indication of the component of the computing system.

11. The computer-implemented system of claim 10, wherein the processor is further configured to apply either the statistical test or the another statistical test to measurements for one or more additional component-level performance metrics, wherein each one of the one or more additional component metrics comprises a metric for one of one or more additional components of the computing system.

12. The computer-implemented system of claim 10, wherein the processor is further configured to automatically apply an adjustment to the component of the computing system in response to determining based on the results of the statistical test or the another statistical test applied to the one or more measurements for the component-level performance metric that there has a been a statistically significant change in the performance of the component of the computing system.

13. The computer-implemented system of claim 10, wherein the processor is further configured to apply a statistical test to measurements for a top-level performance metric for a computing system comprising at least one application and at least one computing device by dividing the measurements into a first time period and a second time period based on times when the measurements were taken.

14. The computer-implemented system of claim 10, wherein the processor is further configured to render a graphical user interface comprising a visual representation of the determined statistically significant change in the performance of the component of the application in the computing system.

15. The computer-implemented system of claim 10, wherein the measurements for the top-level performance metric comprise amounts of time taken by the computing system to complete a specified task.

16. The computer-implemented system of claim 10, wherein the measurements for the top-level performance metric and the one or more measurements for the component-level performance metric are taken for a time period before a change is made to the component and for a time period after the change is made to the component.

17. The computer-implemented system of claim 10, wherein the measurements for the top-level performance metric and the one or more measurements for the component-level performance metric are taken continuously while the computing system is in operation, and further comprising:
dividing the measurements for the top-level performance metric into two time periods based on the times the measurements were taken before applying the statistical test.

18. The computer-implemented system of claim 10, wherein the one or more measurements for the component-level performance metric comprise measurements of an amount of time taken by a routine of the application to complete a task, wherein the task comprises a rendering of an element on a user interface of the computing device, an execution of a database query, a retrieval of data from volatile or non-volatile storage of the computing device, or a sending of a message over a network connection of the computing device.

19. A system comprising: one or more computers and one or more storage devices storing instructions which are operable, when executed by the one or more computers, to cause the one or more computers to perform operations comprising:
applying a statistical test to measurements for a top-level performance metric for a computing system comprising at least one application and at least one computing device;
determining based on results of the statistical test applied to the measurements for the top-level performance metric that there has a been a statistically significant change in the performance of the computing system;
applying either the statistical test or another statistical test to one or more measurements for a component-level performance metric of the computing system, wherein the component-level performance metric comprises a metric for a component of the computing system;
determining based on results of the statistical test or the another statistical test applied to the one or more measurements for the component-level performance metric that there has a been a statistically significant change in the performance of the component of the computing system; and
generating an indication of the component of the computing system.

20. The system of claim 19, wherein the instructions further cause the one or more computers to perform operations further comprising applying either the statistical test or the another statistical test to measurements for one or more additional component-level performance metrics, wherein each one of the one or more additional component metrics comprises a metric for one of one or more additional components of the computing system.
